(19) United States
(12) Patent Application Publication
(10) Pub. No.: US 2015/0144152 A1
(43) Pub. Date: May 28, 2015

(54) FLOSSING DEVICE STRUCTURE

(71) Applicant: Jung-Ching KO, Taichung City (TW)

(72) Inventor: Jung-Ching KO, Taichung City (TW)

(21) Appl. No.: 14/090,557

(22) Filed: Nov. 26, 2013

(51) Int. Cl. A61C 15/04; A61C 15/02

(52) U.S. Cl. CPC A61C 15/046; A61C 15/02
USPC 132/323; 132/329

(57) ABSTRACT

An improved flossing device structure has a main body, and two ends of the main body respectively have an end portion. Each end portion has two correspondingly side edges, wherein at least one end portion is disposed with a row of teeth portion. The row of teeth portion is formed by recessing several concave cavities along the side edge of the end portion, wherein each concave cavity is recessed toward a top end direction of the end portion to allow the side edge of the end portion to form several hook portions reversely extended toward the top end direction of the end portion, and the top edge of the hook portion is leveled with the side edge to prevent gingiva from being slashed by the hook portions.

### BACKGROUND OF THE INVENTION

1. Field of the Invention

The invention relates to a flossing device structure, and more particularly to a flossing device capable of forming orderly teeth shape.

2. Description of the Related Art

A flossing structure in conventional flossing devices is shown in FIG. 8. A barb structure 31 showing sharp shape is outwardly stretched from an end portion 3 of the flossing device so that when the flossing device is used in inter-teeth, several sharp teeth 311 hook food residue within inter-teeth to retain oral hygiene.

However, gingiva inside oral cavity is softer and exposed due to lack of protection structures. Consequently, while using the conventional flossing device, gingiva may be easily slashed by the sharped barb structure 31 to cause bleeding, and oral diseases may also rise since wound may be easily infected by bacterial.

How improving the foregoing problems become a primary issue in the invention.

### SUMMARY OF THE INVENTION

Therefore, upon the foregoing problems of prior art, it is an objective of the present invention to provide a flossing device structure, wherein its end portions are formed with barb flossing structure having orderly teeth shape to supply effect of preventing gingiva from being slashed during usage.

To achieve the foregoing objective, the invention provides an improved flossing device structure having a main body. Two ends of the main body respectively have an end portion. Each end portion has two correspondingly side edges, wherein at least one end portion is disposed with a row of teeth portion. The row of teeth portion is formed by recessing several concave cavities along the side edge of the end portion, wherein each concave cavity is recessed toward a top end direction of the end portion respectively to allow the side edge of the end portion to form several hook portions reversely extended toward the top end direction of the end portion, and a top edge of each hook portion is leveled with the side edge. Each concave cavity has a bottom edge respectively, and the bottom edge is formed with a guide section near the hook portion.

Preferably, the row of teeth portion is formed on one of side edges of the end portion of the main body.

Preferably, the end portion of the main body that is not disposed with the row of teeth portion is disposed with two support arms, and a dental floss is connected to the two support arms.

Preferably, the row of teeth portion is formed at two side edges of one of the end portions of the main body.

Preferably, the end portion of the main body that is not disposed with the row of teeth portion is disposed with two support arms, and a dental floss is connected to the two support arms.

Preferably, the row of teeth portion is formed at one of the side edges of the two end portions of the main body.

Preferably, the row of teeth portion is formed at two side edges of the two end portions of the main body.

Further, each hook portion is a circular arc shape.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a planar schematic diagram according to a first embodiment of the invention;

FIG. 2 is a partially enlarged diagram according to a first embodiment of the invention;

FIG. 3 is a planar schematic diagram according to a second embodiment of the invention;

FIG. 4 is a planar schematic diagram according to a third embodiment of the invention;

FIG. 5 is a planar schematic diagram according to a fourth embodiment of the invention;

FIG. 6 is a planar schematic diagram according to a fifth embodiment of the invention;

FIG. 7 is a planar schematic diagram according to a sixth embodiment of the invention;

FIG. 8 is a partially enlarged diagram of a conventional structure.

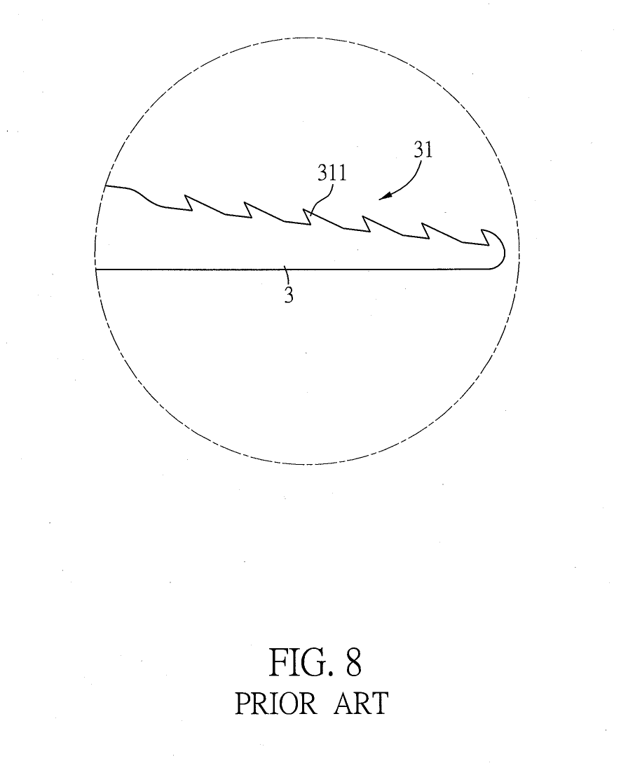

### DETAILED DESCRIPTION OF THE PREFERRED EMBODIMENTS

The technical content of the present invention will become apparent by the detailed description of the following embodiments and the illustration of related drawings as follows.

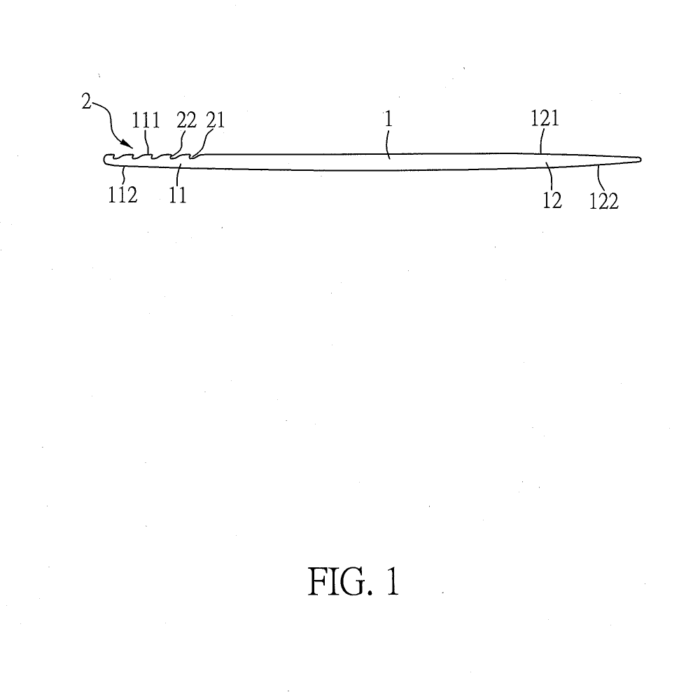

With reference to FIG. 1 to FIG. 7 for an embodiment structure selected by the invention is depicted, and herein is merely provided for depiction and not restricted by the structure in application.

With reference to FIG. 1 for a first embodiment of an improved flossing device structure according to the invention is depicted. The device has a main body 1. Tow ends of the main body 1 have an end portion respectively defining a first end portion 11 and a second end portion 12. Each of end portions 11, 12 has two correspondingly side edges that are respectively defined as a first side edge 111, 121 and a second side edge 112, 122, wherein a side edge of at least an end portion according to the invention is disposed with a row of teeth portion 2. In the embodiment, the row of teeth portion 2 is formed on the first side edge 111 of the first end portion 11.

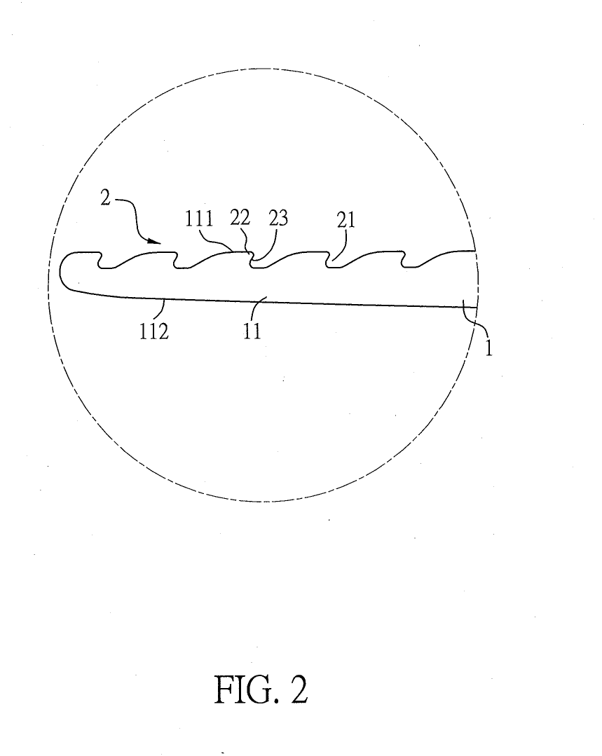

The row of teeth portion 2 is shown in FIG. 2 and formed by recessing several concave cavities 21 along the first side edge 111 of the first end portion 11, wherein each concave cavity 21 is recessed toward a top end direction of the first end portion 11 so that several hook portions 22 reversely extended toward the top end direction of the first end portion 11 are formed on the first side edge 111 of the first end portion 11. In the embodiment, each hook portion 22 is a circular arc shape, and a top edge of each hook portion 22 is leveled with the first side edge 111. Further, a bottom edge of each concave cavity 21 is formed with a guide section 23 near the hook portion 22.

With the shape and arrangement of the row of teeth portion 2, the user can handle the second end portion 12 that is not disposed with the row of teeth portion to stretch the first end portion 11 into the inter-teeth. By utilizing the hook portions 22 of the row of teeth portion 2 that shows the shape of barb relative to extraction direction, food residue within inter-teeth can be hooked by the hook portions 22 while withdrawing the main body 1, and food residue can be locked in the concave cavities 21 along the guide sections 23. Finally, food residue is brought out in accordance with withdraw of the main body 1. Moreover, the hook portion 22 is leveled with the first side edge 11. Although the hook portion 22 is the barb structure, a portion of the hook portion 22, which is in contact with the gingiva, is actually the first side edge 111 so that it may not slash gingiva due to its leveled shapes while using the invention for flossing. Therefore, wounds can be prevented from being infected by bacterial.

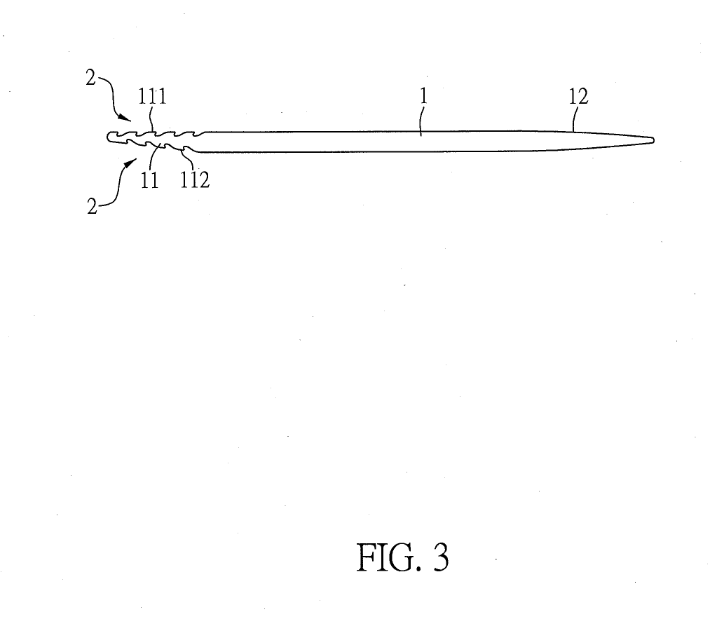

FIG. 3 is a second embodiment according to the invention. The embodiment is that the row of teeth portion 2 is disposed on two side edges 111, 112 of the first end portion 11 to allow the two side edges 111, 112 of the first end portion 11 to have effect of hooking food residue within inter-teeth.

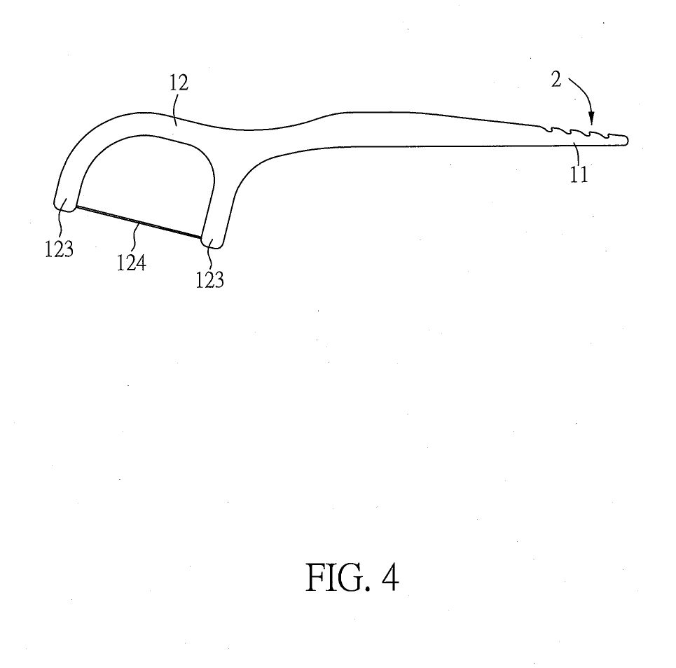

FIG. 4 is a third embodiment according to the invention. The embodiment takes the first embodiment as the basis. Two support arms 123 are extended from the second end portion 12 that is not disposed with the row of teeth portion, and a dental floss 124 is connected to the two support arms 123. Accordingly, the embodiment can use the row of teeth portion 2 at one end to hook food residue within inter-teeth and can also stretch the dental floss 124 at another end into inter-teeth in order to remove food residue.

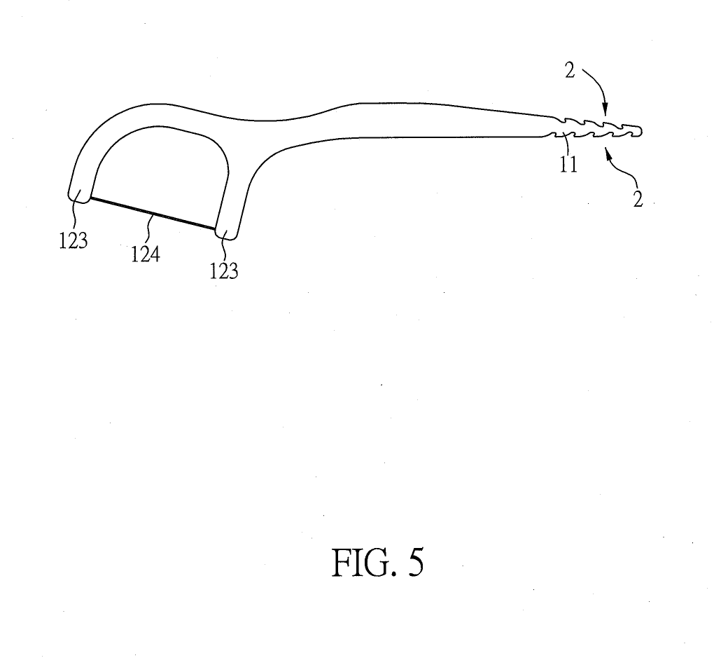

Next, FIG. 5 is a fourth embodiment according to the invention. The embodiment takes the second embodiment as the basis. Two support arms 123 are extended from the second end portion 12 that is not disposed with the row of teeth portion, and a dental floss 124 is connected to the two support arms 123. Accordingly, the embodiment can use two rows of teeth portions 2 at one end to hook food residue within inter-teeth and can also stretch the dental floss 124 at another end into inter-teeth in order to remove food residue.

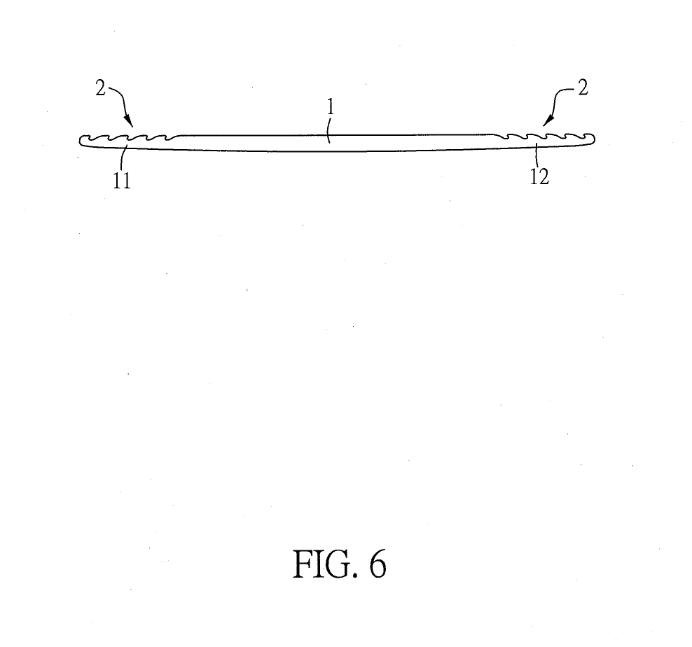

FIG. 6 is a fifth embodiment according to the invention. The embodiment is that the row of teeth portions 2 are respectively disposed to one side edge of the two end portions 11, 12 of the main body 1 to allow the two end portions 11, 12 shown in the embodiment to have effect of hooking food residue within inter-teeth.

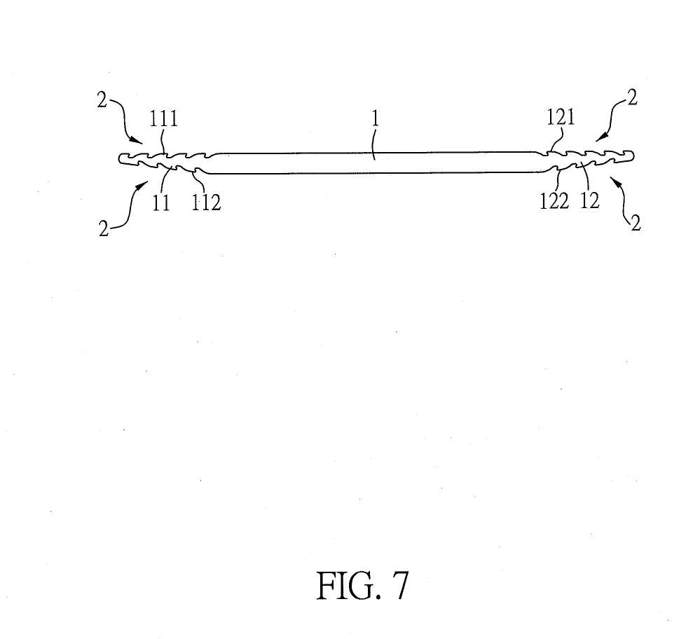

FIG. 7 is a sixth embodiment according to the invention. The embodiment is that the row of teeth portions 2 are respectively disposed at two side edges 111, 112, 121, 122 of two end portions 11, 12 of the main body 1 to allow two ends shown in the embodiment to use their two side edges for hooking food residue within inter-teeth.

While the means of specific embodiments in the present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. An improved flossing device structure having a main body, two ends of the main body respectively having an end portion, each end portion having two correspondingly side edges respectively, wherein at least one end portion is disposed with a row of teeth portion; the row of teeth portion formed by recessing several concave cavities along the side edge of the end portion, wherein each concave cavity is recessed toward a top end direction of the end portion respectively to allow the side edge of the end portion to form several hook portions reversely extended toward the top end direction of the end portion, and a top edge of each hook portion is leveled with the side edge; each concave cavity having a bottom edge respectively, the bottom edge formed with a guide section near the hook portion.

2. The improved flossing device structure of claim 1, wherein the row of teeth portion is formed on one of side edges of the end portion of the main body.

3. The improved flossing device structure of claim 2, wherein the end portion of the main body that is not disposed with the row of teeth portion is disposed with two support arms, and a dental floss is connected to the two support arms.

4. The improved flossing device structure of claim 1, wherein the row of teeth portion is formed at two side edges of one of the end portions of the main body.

5. The improved flossing device structure of claim 4, wherein the end portion of the main body that is not disposed with the row of teeth portion is disposed with two support arms, and a dental floss is connected to the two support arms.

6. The improved flossing device structure of claim 1, wherein the row of teeth portion is formed at one of the side edges of the two end portions of the main body.

7. The improved flossing device structure of claim 1, wherein the row of teeth portion is formed at two side edges of the two end portions of the main body.

8. The improved flossing device structure of claim 1, wherein each hook portion is a circular arc shape.
